(19) United States
(12) Patent Application Publication
(10) Pub. No.: US 2024/0171072 A1
(43) Pub. Date: May 23, 2024

(54) DC/DC CONVERTER DEVICE FOR A WIND TURBINE, AN ELECTRIC DRIVE SYSTEM, OR AN INDUSTRIAL DC SUPPLY NETWORK AND OPERATING METHOD

(71) Applicant: KEBA INDUSTRIAL AUTOMATION GERMANY GMBH, Lahnau (DE)

(72) Inventors: Johannes Visosky, Weimar (DE); Heiko Bach-Preckwinkel, Dortmund (DE)

(21) Appl. No.: 18/283,536

(22) PCT Filed: Mar. 25, 2022
(86) PCT No.: PCT/EP2022/058013

§ 371 Date: Sep. 22, 2023

(30) Foreign Application Priority Data
Mar. 31, 2021 (DE) 10 2021 108 280.3

(51) Int. Cl. H02M 3/158; H02M 1/00; H02M 1/44

(52) U.S. Cl. CPC H02M 3/158; H02M 1/0058; H02M 1/44

(57) ABSTRACT

A DC/DC converter device is for operating a wind turbine, electric drive system or industrial DC network with electrical energy, in particular by means of an intermediate circuit—couplable to the DC/DC converter device—of an AC/DC converter of a DC energy source or of a DC energy store. An input intermediate circuit has a number of intermediate circuit capacitors connected between a positive input conductor and a negative input conductor. A DC/DC converter, connected downstream of the input intermediate circuit, has a first half bridge connected to the positive input conductor and a second half bridge connected to the negative input conductor. A center tap of the first half bridge and a center tap of the second half bridge are connected via a choke. A method is also provided.

### CROSS-REFERENCE TO RELATED APPLICATIONS

This application is the U.S. National Stage of PCT/EP2022/058013 filed on Mar. 25, 2022, which claims priority to German Patent Application 102021108280.3 filed on Mar. 31, 2021, the entire content of both are incorporated herein by reference in their entirety.

### FIELD OF THE INVENTION

The invention relates to a DC/DC converter device for a wind turbine, for an electric drive system or for an industrial DC supply network with electrical energy by means of an intermediate circuit—couplable to the DC/DC converter device—of an AC/DC converter, of a DC energy store or of an energy source. The invention further relates to a method for operating such a DC/DC converter device.

### BACKGROUND OF THE INVENTION

The present technical field relates to DC energy supply or backup of a wind turbine, connection of an intermediate circuit of at least one electric drive or for DC energy supply or backup for a DC industrial network, in this case preferably charging and discharging operation of an energy store or coupling of DC subnetworks or network segments with different voltage levels. In network operation of a DC system, for example a DC industrial network or an intermediate circuit of an electric drive, in particular in high-security applications such as a pitch or yaw drive of a wind turbine, both an AC/DC converter and a DC/DC converter (direct current converter) can be used for a network-side AC or DC supply. In the field of electric drives, DC intermediate circuits are used in frequency inverters or for DC supply, which are couplable to one another or to DC energy sources or to energy sinks.

In this connection, document EP 2 515 424 B1 shows for example a DC converter for stepping up and/or down of voltages for supplying a third DC terminal by a DC voltage source connected to a first terminal and by a DC voltage source connected to a second terminal, for example two solar modules of a solar generator or two batteries. To do so, at least one first terminal, at least one second terminal and at least one third terminal is comprised, wherein an energy flow is possible between the first and second terminals on the one hand and the third terminal on the other hand, of a cyclically operable first half bridge which is connected in parallel to the first terminal and has a series connection of at least one first switching device and a second switching device, and of a cyclically operable second half bridge which is connected in parallel to the second terminal and has a series connection of at least one third switching device and at least one fourth switching device, wherein the midpoints of the two cyclically operable half bridges are connected to one another via at least one choke, wherein this at least one choke is operated as a flying inductance. It is disadvantageous that an input potential of the first terminal, and parallel thereto an input potential of the second terminal, are galvanically connected to an output potential of the third terminal via potential rails, such that no activation between the two inputs and the output is possible. Furthermore, two input DC energy sources must be provided to supply an output DC energy sink.

In addition, DE 10 2014 203 157 A1 relates to a bipolar high-voltage network for an aircraft or spacecraft having a reference potential terminal. This network has two DC voltage converter modules inserted into the converter circuit such that they comprise two half bridges connecting the input and output intermediate circuit rails, and their center taps are each connected via a choke to a reference potential of the output intermediate circuit which is connected to ground potential. To do so, the output circuit is designed bipolar, and a reference potential is connected to ground for short-circuit detection. The two half bridges of the two DC converter modules are separate in terms of control, meaning that at least two chokes must be used, and the two chokes are not operable as a flying inductance since there is a connection to ground in each case. Hence a quasi-isolation is not achievable and both half bridges are separate in terms of control, so that isolation between the input and output circuits cannot be assured. A short-circuit capacity of the output terminal against ground therefore cannot be guaranteed.

However, the present invention can also be used in a charging station for charging and/or discharging an energy store of an electric vehicle.

### SUMMARY OF THE INVENTION

An object of the present invention is to provide an improved DC/DC converter device for operating a wind turbine, an electric drive system or a DC energy network.

The object set is solved by a DC/DC converter device with the features disclosed herein and by a method with said features.

According to a first aspect, a DC/DC converter device, in particular a transformerless DC/DC converter device, is proposed for operating a wind turbine, an electric drive or an industrial DC supply network. The charging station comprises:
an input intermediate circuit which has a number of intermediate circuit capacitors connected between a positive input conductor and a negative input conductor, and
a DC/DC converter connected downstream of the input intermediate circuit, which has a first half bridge connected to the positive input conductor and a second half bridge connected to the negative input conductor, wherein the center tap of the first half bridge and the center tap of the second half bridge are connected via a choke.

The DC/DC converter device has for example a housing, in particular a watertight housing, having an interior in which are arranged a plurality of electric and/or electronic components and a connection socket connected to at least one of the components for connecting a connection plug or charging plug for an energy store, for example of an electric vehicle.

The DC/DC converter device may be used as a charging connection device for an electric vehicle, for example. The converter device may be designed in particular as a wallbox. The converter device may be used for charging or regenerating an energy store of an electric vehicle or an emergency energy store of a wind turbine, for coupling or emergency energy backup of intermediate circuits of electric drives, or for adjusting voltage levels in DC industrial networks. The DC/DC converter device acts here as a reference source for electrical energy for the energy store. The DC/DC converter device may also be referred to as an intelligent charging device for an energy store.

Examples for the electric and/or electronic components of the DC/DC converter device comprise a contactor, all-current-sensitive circuit breaker, direct current/overcurrent/fault current monitoring device, relay, connecting terminal, electronic circuits and a control device, for example comprising a PCB, on which are arranged a plurality of electronic elements for controlling and/or measuring and/or monitoring the energy states.

An AC/DC converter included in the DC/DC converter device for an AC or three-phase network connection may also be referred to an inverter. The AC/DC converter is configured in particular for converting an AC voltage into a DC voltage and/or for converting a DC voltage into an AC voltage. The DC/DC converter device comprises an input intermediate circuit, in particular connected downstream of such an inverter, with a number of intermediate circuit capacitors that are connected to an input intermediate circuit center point.

The multiphase three-phase network i has in particular a number of phases, for example L1, L2 and L3, and a neutral conductor (also referred to as N).

It must be noted that “charging and/or discharging an energy store” comprises both the supply of electrical energy and the withdrawal of electrical energy. This means that the energy store can act as a consumer or as a producer in the DC network of the wind turbine, electric drive or industrial network.

According to one embodiment, an AC/DC converter couplable to a number of AC phases L1, L2, L3, in particular a 3-point AC/DC converter, may be connected upstream of the input intermediate circuit at the input-side input conductors, or a DC energy source, in particular a solar generator, or a DC energy store, in particular a 3-point battery, may be connected at the input-side input conductors, i.e. to the source-side input intermediate circuit. It is thus possible in normal operation for DC energy to be withdrawn or re-stored from the DC output terminals of a network rectifier or bidirectionally operating AC/DC converter, or withdrawn from a DC energy source, for example a fuel cell, a solar generator with solar cells, a flywheel mass store or a battery, or withdrawn or returned to a DC energy store, for example an electrochemical battery, capacitor or flywheel mass store. A wide range of uses is thus possible for energy withdrawal and re-storage between various DC voltage levels.

According to one embodiment, at least one pitch drive, or a yaw drive of a wind turbine, at least one intermediate circuit of one or more electric drives, or at least one DC network segment of a DC industrial network, can be connected downstream of an output intermediate circuit of the DC/DC converter. This results in a variety of advantages when the DC/DC rectifier unit is used in the field of a wind turbine or drive system or in a DC industrial network:
With DC networks, electrical supply in factories can be designed with greater energy efficiency, stability and flexibility than with network AC current by using electronic frequency inverters. If all electrical systems are coupled using an intelligent DC network, such as in the joint project “DC Industrie 2” in Germany, for example, this also advances the energy revolution in the industrial field. In a DC industrial application, stepping a DC supply voltage up and down is possible bidirectionally without transition with the aid of the proposed DC/DC converter device. There is also a safe switch-off option and a short reaction time to short-circuits and ground faults. This may be achieved in particular by the connection between input and output of the DC/DC converter device being made exclusively by junction capacitances of semiconductor switches, i.e. no galvanic connection exists between input and output and a quasi-isolation is possible. In this case, the DC converter device can continue to operate without any restriction in the event of a ground fault. In addition, there are the options of connecting and using it in various applications when linking energy stores, for example in:
DC intermediate circuits of drive systems; network failure backup, peak load reduction, braking energy accumulation instead of braking resistance of electric drives in generator operation;
Bidirectional coupling of two or more DC intermediate circuits of drive systems, in particular at differing voltage levels;
Provision of several DC network segments, in particular at various voltage levels, in an industrial hall;
Connection of various DC network segments in an industrial hall with the option of load shedding, preloading, voltage adjustment;
Connection of photovoltaic system, fuel cell, flywheel mass store to a DC network segment in an industrial hall.

Furthermore, quasi-isolation between the input side and the load side is enabled, so that increased safety, ground fault resistance and short-circuit resistance is achievable.

In the field of wind turbines, the use of the proposed DC/DC converter device is advantageous, in particular in the DC intermediate circuit network of a pitch drive and yaw drive of a wind turbine. A pitch drive determines the angle of attack of one or more rotor blades relative to the wind, while a yaw drive defines the horizontal alignment of the nacelle of the wind turbine relative to the wind.

For example, EP 1 852 605 B1 proposes a voltage adjustment of an emergency energy store for a pitch drive at a DC intermediate circuit, such that a DC voltage level as for normal operation can be achieved largely independently of the voltage level of the emergency energy store in emergency operation, and energy can be received in the emergency energy store in generator operation. The proposed DC/DC converter device thus also enables flexible connection of the emergency energy store for pitch and yaw drives in wind turbines, in particular for a range of different types of emergency energy stores, such as lead-acid or lithium-ion batteries or capacitors, in particular SuperCaps or UltraCaps.

Previously there has been an upper limit for voltage levels in emergency energy stores in comparison to the network voltage, in particular the voltage level of the energy store always had to be lower than that of the rectified network voltage. Heavy network fluctuations, especially in a wind turbine or in electric drives, are problematic here and can lead to this condition being temporarily unable to be met. As a result, an even greater restriction may be necessary when designing the emergency energy store, such that the emergency energy store voltage has to be designed markedly lower than the rectified rated network voltage. With the aid of the proposed DC/DC converter device, elimination of this upper limit is made possible by bidirectional stepping up and down with a continuous transition. This results in the following advantages:
Differing requirements during use can be met by a DC/DC converter device, in particular high or low emergency energy store voltages can be made available;
A high emergency energy store voltage allows lower currents to be used, permitting the use of less expensive cables with a smaller cable cross-section and a smaller space requirement for the interfaces, and hence easier and less expensive installation;
The operating safety can be maintained or stabilized with a fluctuating input-side network voltage, which is crucial in particular during the use of wind turbines or for safety-critical electric drives;
Several DC/DC converters and hence several pitch drives can be connected to an emergency energy store thanks to the achievable quasi-isolation;
A highly dynamic voltage utilization to a point close to deep discharge, for example of capacitor stores, permits both coupling of energy stores that provide markedly higher voltages than a DC intermediate circuit and operation of these until almost complete discharge, so that the energy content of the energy store can be exploited to the full.

In particular, a control unit is provided which can control single or all elements and units of the DC/DC converter device. Furthermore, the choke of the DC/DC converter is preferably operable as a flying inductance. The DC/DC converter with the flying inductance can here advantageously act to meet the function of quasi-isolation. For example, the DC/DC converter has a number of semiconductor switching elements, which are designed for example as MOSFETs. In particular, the DC/DC converter operates as a voltage inverter, with the DC/DC converter preferably being controlled in such a way that the diodes of the MOSFETs never become conducting in an undesirable way during undisrupted operation. The inductance moves back and forth preferably between the input potential and the output potential during operation. This results in functional terms in quasi-isolation. In the case of a ground fault in the output side, for example at an emergency energy store for a pitch drive (battery), the potential of the energy store can freely shift without disruption relative to the potential of the input intermediate circuit of the DC/DC converter device. The regulation of the choke current is preferably not affected in the event of a ground fault. The duty cycle too of the DC/DC converter does not have to be changed.

The proposed DC/DC converter preferably behaves in functional terms like a DC/DC converter with transformer. The output potential against ground can freely shift within certain limits during operation without this affecting the function of the DC/DC converter. This is in particular the case when there is no galvanic connection between the input side and the output side except for a connection by the two half bridges.

In the case of a grounded input network, it is possible by appropriately dimensioning the semiconductor switching elements of the DC/DC converter for a person to touch a terminal of the output of the DC/DC converter device without a substantial DC current passing through that person's body.

According to one embodiment, the choke of the DC/DC converter is operable as a flying inductance.

According to a further embodiment, the DC/DC converter device is a transformerless DC/DC converter device.

According to a further embodiment, the DC/DC converter is designed as a bidirectional DC/DC converter for stepping voltages up and/or down. The DC/DC converter may also be referred to as a direct current converter. The DC/DC converter is in particular designed symmetrical and can step down and up in both directions.

According to a further embodiment, the respective half bridge comprises a series connection of two semiconductor switching elements. The center tap of the half bridge is between the two semiconductor switching elements connected in series.

According to a further embodiment, the respective semiconductor switching element is designed as a MOSFET, preferably as a SiC MOSFET, or as an IGBT or as a SiC cascode.

In particular, the present topology acts as a bidirectional voltage transformation device (DC transformer), wherein the voltage transformation, which is settable by the control unit, depends on the ratio between the switch-on duration and the switch-off duration of the semiconductor switching elements. With a duty cycle of 50% in each case, the voltage transformation ratio is 1.

According to a further embodiment, the DC/DC converter device comprises a control unit which is configured to control the semiconductor switching elements, such that two corresponding semiconductor switching elements each of the two half bridges switch simultaneously, in particular with an identical switch-on time-lag.

In particular, the two input-side, i.e. source-side, semiconductor switching elements of the two half bridges are simultaneously switchable to achieve a quasi-isolation, and the two load-side, i.e. output-side, semiconductor switching elements of the two half bridges are also simultaneously switchable.

In a further embodiment, the DC/DC converter device may have a control unit which is configured to control the two half bridges H1 and H2 with a phase shift, in particular with a 180° phase shift. In particular when a coupling line is connected between the intermediate circuit center points of an input-side and output-side capacitor bridge, as described further below, phase-shifted, in particular phase-inverted, control of the half bridges is possible, in contrast to in-phase control of the half bridges. Quasi-isolation is abandoned here, since a galvanic connection is made between the input and output sides. This allows the efficiency of the DC/DC converter device to be increased considerably, and on the other hand allows the chokes to be designed smaller and less expensive.

In this context, the terms “input-side” and “source-side”, or “output-side” and “load-side”, should be understood only as topological definitions of the two connection sides of the DC/DC inverter device, thereby illustrating an energy flow direction during normal operation. However, the energy can also flow, in a bidirectional operation in the meaning of the invention, from the output or load side to the input or source side. Energy can thus flow from the load-side emergency energy store to the source-side DC intermediate circuit in an inverse operating mode of an application for powering a pitch drive in emergency operation, or energy can be transferred from a DC industrial network into an AC supply network in generator operation, while in regular operation the energy flow is reversed. In the case of coupled intermediate circuits for drive-related systems, energy can if required be passed for example from a first into a second intermediate circuit in the case of a high energy load for backup of the voltage level of the second intermediate circuit.

In particular, the control unit does not at any time switch on the semiconductor switching elements of a half bridge simultaneously in order to prevent a direct connection between the input side and the load side.

According to a further embodiment, an interference suppressor is arranged between the input intermediate circuit and the DC/DC converter, which has two interference suppression capacitors connected in parallel to the intermediate circuit capacitors. The node connecting the two interference suppression capacitors is connected to ground potential. The ground potential may also be referred to as mass or earth in the following.

According to a further embodiment, the DC/DC converter device comprises an output intermediate circuit connected downstream of the DC/DC converter and having a number of output capacitors which are connected between a negative output potential tap and a positive output potential tap of the DC/DC converter device.

Advantageously, the intermediate circuit capacitors of the input intermediate circuit can form an input capacitor bridge with an input intermediate circuit center point to expand on the preceding embodiment, and the output capacitors of the output intermediate circuit can form an output capacitor bridge with an output intermediate circuit center point. The two intermediate circuit center points, i.e. the input intermediate circuit center point and the output intermediate circuit center point, can be connected via a coupling line. The midpoint potentials of the input and of the output are galvanically coupled to one another. This improves in particular the efficiency and the EMC behavior of the DC/DC inverter device. According to a further embodiment, a load-side, i.e. output-side, interference suppressor is arranged between the DC/DC converter and the output intermediate circuit. The load-side interference suppressor has two interference suppression capacitors connected in parallel to the number of output capacitors of the output intermediate circuit, wherein the node connecting the two interference suppression capacitors is connected to ground potential. It is furthermore possible using the coupling line to control the half bridges H1 and H2 with a phase shift, in particular phase-shifted by 180°, i.e. phase-inverted. With this type of control a considerably increased efficiency of the DC/DC converter device can be achieved on the one hand, and the choke can be designed smaller and less expensive on the other hand.

According to a further embodiment, the control unit is configured to control the semiconductor switching elements such that the input-side semiconductor switching element of the first half bridge and the load-side semiconductor switching element of the second half bridge have overlapping switch-on times, and/or that the input-side semiconductor switching element of the second half bridge and the load-side semiconductor switching element of the first half bridge have slightly overlapping switch-on times. The ratio of the switch-on times of the input-side semiconductor switching elements to the switch-on times of the load-side semiconductor switching elements corresponds here preferably to a predetermined quotient.

This control with overlapping switch-on times causes a charge shift in the interference suppression capacitors, which in the Figures have the reference numerals 651, 652, such that the potential of the output network is settable relative to ground potential. This allows balancing of the output potential relative to ground potential (mass) to be achieved. When an aforementioned coupling line is inserted between capacitor bridges of the input and of the output, for example as shown according to FIG. 4a, an overlap with control phase-shifted by 180° can improve efficiency. A phase shift slightly diverging from 180° can alter the balance of the output potential relative to the input intermediate circuit center point.

The control unit may be implemented with hardware and/or with software. In the case of a hardware implementation, the control unit may be designed as a device or as part of a device, for example as a computer or microprocessor or control computer. In the case of a software implementation, the control unit may be designed as a computer program product, as a function, as a routine, as part of a program code or as an executable object.

According to a further embodiment, the control unit is configured to switch off one of the input-side semiconductor switching elements of the two half bridges earlier than the other input-side semiconductor switching element of the two half bridges, such that coupling of an input-side primary circuit and of a load-side secondary circuit is made possible or is provided via the choke.

According to a further embodiment, the control unit is configured to switch off one of the load-side semiconductor switching elements of the two half bridges earlier than the other load-side semiconductor switching element of the two half bridges, such that—unless a coupling line is provided, and a quasi-isolation is achievable—coupling of an input-side primary circuit and of a load-side secondary circuit is made possible or is provided via the choke.

According to a further embodiment, the semiconductor switching elements are MOSFETs. The control unit is configured here to control the gates of the MOSFETs of the half bridges with control signals phase-shifted such that—unless a coupling line is provided, and a quasi-isolation is achievable—coupling of an input-side primary circuit and of a load-side secondary circuit is made possible or is provided via the choke.

In this embodiment, the balance of the output voltage against ground may be controlled by a slight phase shift of the control signals of the first half bridge and of the second half bridge relative to one another.—Unless a coupling line is provided, and a quasi-isolation is achievable, the phase shift results periodically in a brief coupling of the input circuit and of the output circuit. This also applies when no active power is transferred by the DC/DC converter.

According to a further embodiment, the control unit has a load current controller, a balancing current controller and a differential voltage controller. The load current controller is here configured to set the ratio of the switch-on times of the input-side semiconductor switching elements to the switch-on times of the load-side semiconductor switching elements. The balancing current controller is configured to provide a setting signal for balancing the potential at the negative output potential tap and the potential at the positive output potential tap relative to ground potential. Furthermore, the differential voltage controller is configured to provide a set value for the setting signal depending on at least one measured voltage in the load-side secondary circuit.

According to a further embodiment, the differential voltage controller is slower than the balancing current controller.

According to a further embodiment, the anode of a first diode is coupled to the negative output potential tap and the cathode of the first diode is coupled to the input intermediate circuit center point. Furthermore, the anode of a second diode is coupled to the input intermediate circuit center point and the cathode of the second diode is coupled to the positive output potential tap.

According to a further embodiment, the anode of the first diode is connected to the negative output potential tap and the cathode of the first diode is connected to the input intermediate circuit center point. Furthermore, the anode of the second diode is connected to the input intermediate circuit center point and the cathode of the second diode is connected to the positive output potential tap.

According to a further embodiment, an overvoltage protection element is coupled between the input intermediate circuit center point and a node to which the cathode of the first diode is connected and to which the anode of the second diode is connected. The overvoltage protection element is in particular a varistor or a bidirectional suppressor diode, for example a bidirectional transil diode.

According to a further embodiment, a series connection made from a first overvoltage protection element and the first diode is arranged between the input intermediate circuit center point and the negative output potential tap. A series connection made from a second overvoltage protection element and the second diode is further arranged between the input intermediate circuit center point and the positive output potential tap.

According to a further embodiment, an EMC filter device and an LCL filter device connected downstream of the EMC filter device are coupled between three input-side connecting terminals for the three phases of the multiphase network, and the AC/DC converter. The LCL filter device comprises preferably at least three chokes and three capacitors.

According to a further embodiment, the AC/DC converter is designed as a 3-point AC/DC converter.

According to a further embodiment, a polarity reversal capacitor is connected to the center tap of the first half bridge and is connected in parallel to the input-side semiconductor switching element of the first half bridge, wherein a further polarity reversal capacitor is connected to the center tap of the first half bridge and is connected in parallel to the load-side semiconductor switching element of the first half bridge. Furthermore, a polarity reversal capacitor which is connected in parallel to the input-side semiconductor switching element of the second half bridge is connected to the center tap of the second half bridge, while a polarity reversal capacitor which is connected in parallel to the load-side semiconductor switching element of the second half bridge is connected to the center tap of the second half bridge. The polarity reversal capacitors effect a soft switching and hence a reduction in the switching losses. The polarity reversal capacitors may also be referred to as ZVS capacitors or snubber capacitors (ZVS: zero voltage switching). To that extent, a polarity reversal capacitor may be advantageously arranged in parallel to each semiconductor switching element in order to achieve loss-reduced switch-off.

According to a further embodiment, the DC/DC converter device comprises a power switching device for safe disconnection of the number of input conductors from the input side, for example a multiphase AC network. The power switching device may be designed as an electromechanical element, for example a contactor or a four-phase relay. The power switching device may be designed individually for a respective phase of the multiphase AC network and/or for a respective input conductor of the switching matrix, and be controllable such that for example individual assignments can be interrupted by means of the power switching device.

According to a second aspect, a method is proposed for operating a DC/DC converter device for operation of a wind turbine, of an electric drive or of an industrial DC supply network with electrical energy, wherein the DC/DC converter device comprises an intermediate circuit which has a number of intermediate circuit capacitors connected between a positive input conductor and a negative input conductor, and a DC/DC converter connected downstream of the input intermediate circuit and having a first half bridge connected to the positive input conductor and a second half bridge connected to the negative input conductor. The method comprises operation of a choke, connecting the center tap of the first half bridge (H1) and the center tap of the second half bridge, of the DC/DC converter as a flying inductance.

This method has the same advantages set forth for the DC/DC converter device according to the first aspect. The embodiments described for the proposed DC/DC converter device apply for the proposed method accordingly. In addition, the definitions and explanations relating to the DC/DC converter device also apply for the proposed method accordingly.

“One/a/an” is here not necessarily to be understood as a restriction to precisely one element. Instead, several elements, for example two, three or more, may be provided. Every other numeral used here is also not to be understood to mean that there is any restriction to precisely the stated number of elements: upward and downward divergences in the number are also possible, unless stated to the contrary.

Further possible implementations of the invention also comprise not explicitly stated combinations of features or embodiments, described previously or in the following in relation to the examples. The person skilled in the art will also add individual aspects as improvements or additions to the respective basic form of the invention.

### BRIEF DESCRIPTION OF THE DRAWINGS

Further advantageous configurations and aspects of the invention are disclosed herein and of the examples of the invention described in the following. The invention is explained in more detail below on the basis of preferred embodiments with reference to the enclosed figures.

FIG. 1a, lb shows schematically two arrangements of a first embodiment of a DC/DC converter device for operation of a DC industrial network and of a wind turbine;

FIG. 2 shows a schematic diagram of a second embodiment of a DC/DC converter device for charging and/or discharging an energy store;

FIG. 3 shows a schematic diagram of a further embodiment of a DC/DC converter device;

FIGS. 4a, 4b show schematic diagrams of a third and fourth embodiment of a DC/DC converter device;

FIGS. 5a, 5b show schematic diagrams of a fifth and of a further embodiment of a DC/DC converter device;

FIG. 6 shows a schematic diagram of a sixth embodiment of a DC/DC converter device for supplying an output-side DC network from a DC input circuit;

FIG. 7 shows the schematic diagram from FIG. 6 with input-side primary circuit and load-side secondary circuit included;

FIG. 8 shows the schematic diagram from FIG. 6 with circuit of the balancing current included;

FIG. 9 shows diagrams to illustrate the choke current and various signals of the DC/DC converter according to FIGS. 7 and 8;

FIG. 10 shows the schematic diagram from FIG. 6 with balance control included; and

FIG. 11 shows a schematic flow diagram of a method for operating a DC/DC converter device.

### DETAILED DESCRIPTION OF THE INVENTION

The same reference numerals have been used to identify elements that are identical or similar in the figures, unless otherwise stated.

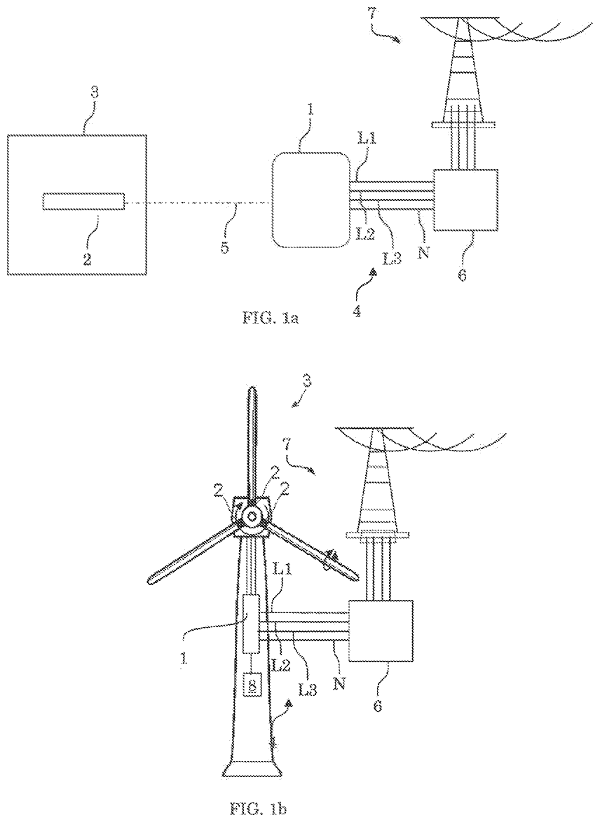

FIGS. 1a and 1b show schematically arrangements with a first embodiment of a DC/DC converter device 1 for operating a DC industrial network (FIG. 1a) or an emergency energy store 2 of a pitch drive 3 in a wind turbine 3 (FIG. 1b).

In the first embodiment in FIG. 1a, a multiphase AC network 4 is connected by means of a network connection point 6 to a multiphase energy supply network 7. The multiphase AC network 4 has in particular a number of phases, for example L1, L2 and L3. This example relates to three-phase current networks, without restriction of generality. A DC industrial network 3 having at least one or more DC network segments 2, preferably with differing voltage levels and/or galvanically isolated, is coupled to the AC network 4 via the DC/DC converter device 1, which comprises an AC/DC converter. Further stand-alone networks 2 with identical or differing voltage levels are conceivable using DC/DC converter devices 1 connectable in parallel. The industrial network 3 can be supplied with DC energy via the DC/DC converter device, wherein the level of the energy is settable largely independently of the voltage level of the AC network 4. It is conceivable that an energy store, for example a high-capacitance battery and/or a solar generator with a plurality of solar cells connected in parallel, can switchably supply energy for at least one stand-alone operation via further DC/DC converters comprised in the DC/DC converter device 1. Rapid load shedding in the event of a fault is just as conceivable as the connection of various types of DC energy source with differing or fluctuating voltage level, which is possible without risk thanks to quasi-isolation.

According to the example from FIG. 1b, a DC/DC converter device 1 is comprised in a wind turbine 3, which comprises a plurality of rotor blades adjustable by means of pitch drives 3. The DC/DC converter device 1 couples a DC energy store 8 to an intermediate circuit of a pitch motor inverter that controllably operates the pitch motors 2. One DC/DC converter device 1 may be provided per pitch motor 2 and in each case couple an energy store 8, but also couple a common energy store 8 to the three pitch motor intermediate circuits thanks to the quasi-isolation. The DC/DC converter device permits, continuously and with a heavily fluctuating voltage level of the intermediate circuit, provision of a required DC voltage level, regardless of the nominal voltage or charge capacity of the DC energy store 8. The absence of an upper limit for the emergency energy store voltage in comparison with the network voltage allows both the use of energy stores 8 whose nominal voltage is considerably higher than the DC intermediate circuit voltage of the pitch inverter, and of the energy store 8, which provides a far lower voltage level. At high voltage levels, cables with smaller cross-sections can be used due to reduced currents.

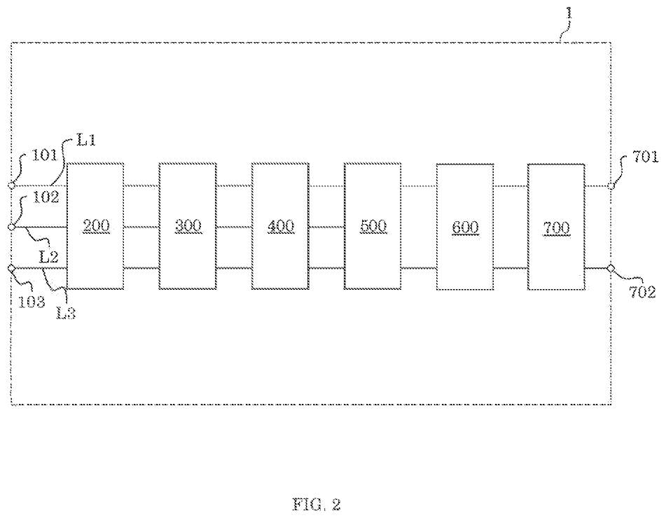

The DC/DC converter device 1 may have a number of electric and/or electronic components (not shown in FIG. 1a, lb, see for example FIG. 2) and is intended for DC voltage conversion between input side and output side, in particular for operation of a DC industrial network or of several network segments thereof; for coupling intermediate circuits of one or more, in particular frequency-converted, drive systems; or for backup of the emergency supply to a pitch or yaw drive of a wind turbine by means of an emergency energy store couplable to a drive-related intermediate circuit.

FIG. 2 shows a schematic diagram of a second embodiment of a DC/DC converter device 1 for DC supply to an industrial network 3 made of a multiphase network 4, which comprises an upstream-connected AC/DC converter 400. The second embodiment in FIG. 2 shows in depth features of the first embodiment according to FIG. 1a.

The DC/DC converter device 1 in FIG. 2 has three connecting terminals 101, 102, 103 for the three phases L1, L2, L3 of the multiphase network 4. The DC/DC converter device 1 may also have a further connecting terminal (not shown) for the neutral conductor.

According to FIG. 2, an EMC filter device 200 is connected downstream of the connecting terminal 101, 102, 103. Furthermore, the DC/DC converter device 1 in FIG. 2 comprises an LCL filter device 300 connected downstream of the EMC filter device 200, an AC/DC converter 400, an input intermediate circuit 500, a DC/DC converter 600 and an output intermediate circuit 700, to which a negative output potential tap 701 and a positive output potential tap 702 are connected.

In particular, an EMC filter device (not shown) may be connected between the negative output potential tap 701 and the positive output potential tap 702.

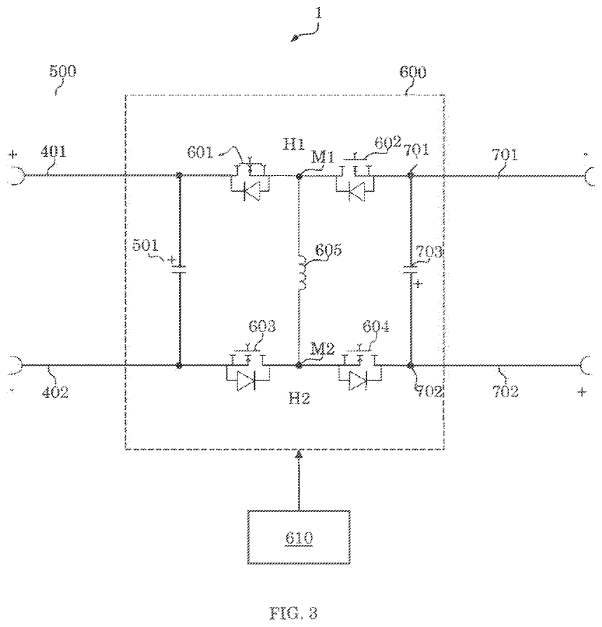

FIG. 3 shows a DC/DC converter 600 with integrated input intermediate circuit capacitor 501 and output capacitor 703 of an embodiment of a DC/DC converter device 1, explaining the basic principle of DC/DC conversion. The latter comprises two half bridges H1, H2 with two semiconductor switching elements 601, 602 and 603, 604 respectively, that are connected between the positive input conductor 401 and the negative output potential tap 701, and between the negative input conductor 402 and the positive output potential tap 702 respectively. A choke 605 is connected between the center taps M1, M2 of the two half bridges H1, H2 as a flying inductance. An intermediate circuit capacitor 501 is connected in the input intermediate circuit 500 and an output capacitor 703 is connected in the output intermediate circuit 700. The semiconductor switching elements 601 to 604 are controlled by a control unit 600. Depending on the control of the semiconductor switching elements 601 to 604 of the two half bridges H1, H2 by the control unit 600, both a step up and a stepdown topology can be provided bidirectionally both from the input conductors 401, 402 to the output conductors 701, 702 and vice versa during the interaction of the choke 605 and the capacitors 501 and 703 respectively. This allows DC energy to be transported bidirectionally from the input side 500 to the output side 700 and also vice versa, and the respective output voltages to be continuously varied regardless of the respective input voltages.

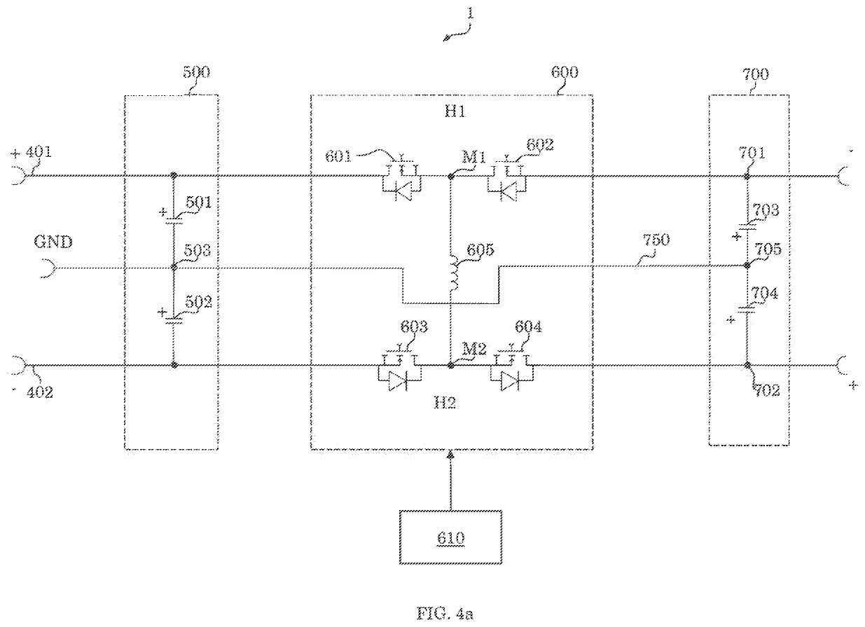

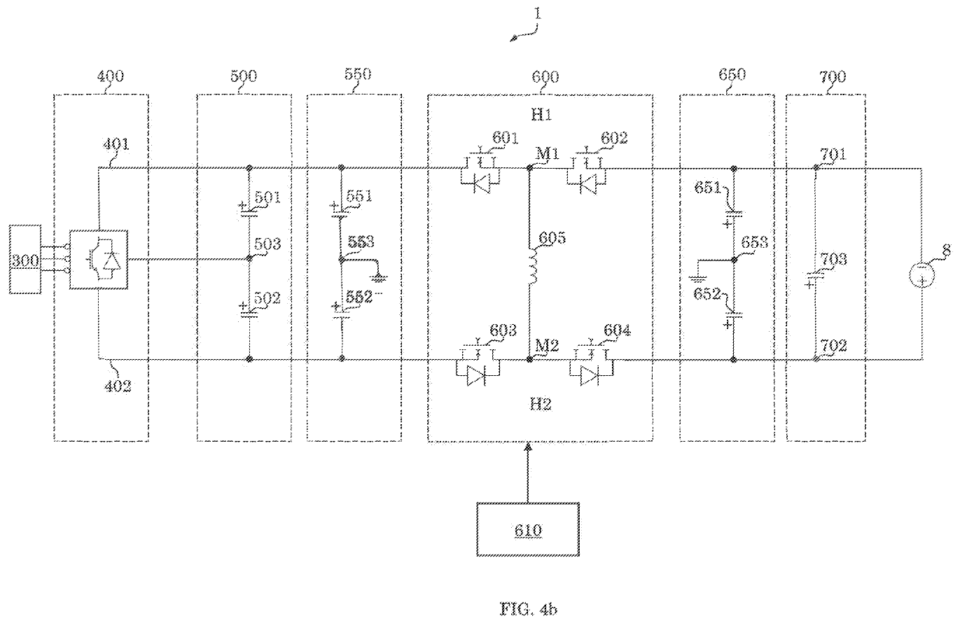

FIG. 4a shows a schematic diagram of a third embodiment of a DC/DC converter device 1 that allows conversion of a +/− input voltage, symmetrical relative to a GND potential, of the input potential conductor 401, 402 into a DC voltage, symmetrical or displaceable within certain limits relative to a GND potential, at the output potential taps 701, 702. A symmetrical GND midpoint potential can be fed in on the input side, in particular when a 3-point AC/DC converter is used, however this can also be dispensed with. The third embodiment of FIG. 4a comprises all the features of the second embodiment according to FIG. 3, while FIG. 4a illustrates details of the DC/DC converter device 1.

According to FIG. 4a, the input intermediate circuit 500 has two intermediate circuit capacitors 501, 502 which are connected between a positive input conductor 401 and a negative input conductor 402 and a symmetrical midpoint potential GND of the intermediate circuit center point 503.

The DC/DC converter 600 connected downstream of the input intermediate circuit 500 has a first half bridge H1 and a second half bridge H2. The first half bridge H1 is connected to the positive input conductor 401 and comprises a series connection of two semiconductor switching elements 601, 602. Furthermore, the first half bridge H1 is connected to the negative output potential tap 701.

The second half bridge H2 is connected to the negative input conductor 402 and comprises a series connection of two semiconductor switching elements 603, 604. The respective semiconductor switching element 601, 602, 603, 604 is designed for example as a MOSFET. In addition, the second half bridge H2 is connected to the positive output potential tap 701.

The center tap M1 of the first half bridge H1 and the center tap M2 of the second half bridge H2 are connected via a choke 605.

The inductance of the choke 605 is preferably between 10 μH and 100 μH. The value of the inductance of the choke 605 is in particular selected from the range between 10 μH and 100 μH, depending on the power of the DC/DC converter device 1 and the selected switching frequency.

The choke 605 of the DC/DC converter 600 is in particular operable as a flying inductance.

Furthermore, the DC/DC converter device 1 in FIG. 4a has a control unit 610. The control unit 610 is configured to control the semiconductor switching elements 601, 602, 603, 604 and in particular to control them such that two corresponding semiconductor switching elements 601, 603 and 602, 604 of the two half bridges H1, H2 respectively switch in-phase or phase-inverted, also phase-shifted, in particular switching with an identical switch-on time-lag.

In particular, the two input-side, i.e. source-side, semiconductor switching elements 601, 603 of the two half bridges H1, H2 are here simultaneously switchable, as are the two load-side, i.e. output-side, semiconductor switching elements 602, 604 of the two half bridges H1, H2, in particular in-phase or phase-inverted. The half bridges H1 and H2 are thus operated in-phase. Alternatively, the half bridges H1 and H2 can also be operated with a 180° phase shift, i.e. phase-inverted.

An output intermediate circuit 700 having a number of output capacitors 703, 704 is connected downstream of the DC/DC converter 600. In the example from FIG. 4a, the output intermediate circuit 700 has—without restriction of generality—an output capacitor bridge with two capacitors 703, 704 connected in series and connected between the negative output potential tap 701 and the positive output potential tap 702 of the DC/DC converter device 1, between which an output intermediate circuit center point 705 is defined. The input intermediate circuit center point 503 and the output intermediate circuit center point 705 are connected to one another via a coupling line 750. The coupling line 750 harmonizes the midpoint potentials of the intermediate circuit center points 503, 705, such that no potential differences arise in this respect and the input and output potentials thus have a common midpoint potential. This is especially advantageous in particular with regard to the efficiency and the EMC stability of the DC/DC converter device.

FIG. 4b is a schematic diagram of a fourth embodiment of a DC/DC converter device 1, which is designed for charging and discharging a DC energy store 8 by means of an AC network 4. The fourth embodiment from FIG. 4b comprises substantial features of the third embodiment according to FIG. 4a, but diverges therefrom in some respects:

The input intermediate circuit 500 has a 3-point AC/DC converter 400 connected upstream of it and providing, from network-side three-conductor phases of a subscriber network 4 which are smoothed by an LCL-filter device 400, an input potential symmetrical around a GND center tap.

The output intermediate circuit 700 comprises a single output capacitor 703, and the coupling line 750 is omitted. As a result, the midpoint potential is freely displaceable between the output potential taps 701, 702 regardless of the midpoint potential at the input intermediate circuit center point 503, and is as a rule held at ground potential during operation. In the event of a ground fault, one of the output potential taps 701 or 702 can be set, without impairment of operation, to ground potential, providing contact protection.

In addition, the DC/DC converter device 1 in FIG. 4b has an interference suppressor 550 arranged between the input intermediate circuit 500 and the DC/DC converter 600. The interference suppressor 550 comprises two interference suppression capacitors 551, 552 connected in parallel to the intermediate circuit capacitors 501, 502. The node 553 connecting the two interference suppression capacitors 551, 552 is connected to ground potential (mass). Furthermore, the DC/DC converter device 1 from FIG. 4b has a load-side interference suppressor 650 arranged between the DC/DC converter 600 and the output intermediate circuit 700. The load-side, i.e. output-side, interference suppressor 650 has two interference suppression capacitors 651, 652 connected in parallel to the output capacitor 703 of the output intermediate circuit 700. The node 653 connecting the two interference suppression capacitors 651, 652 is connected to ground potential (mass).

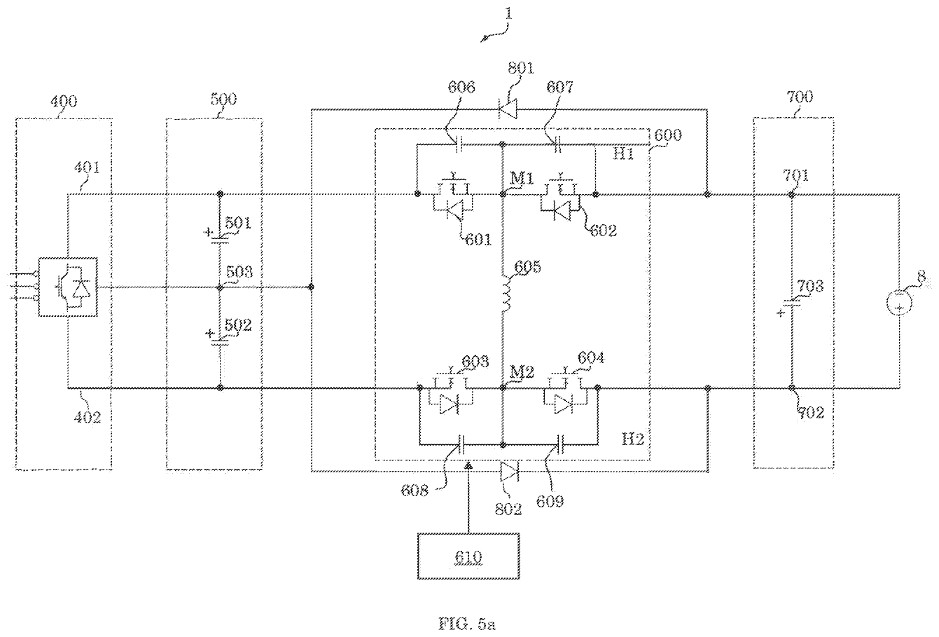

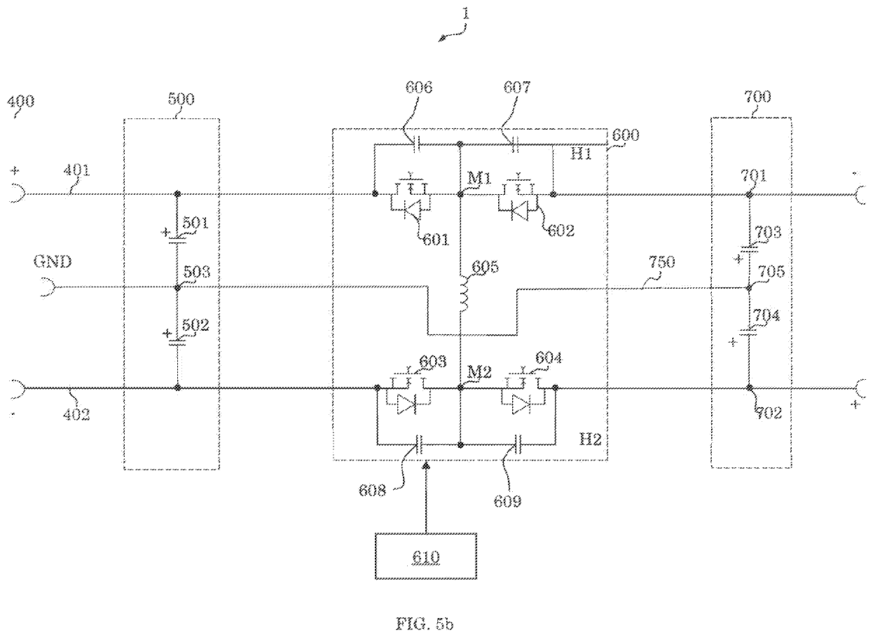

FIG. 5a shows a schematic diagram of a fifth embodiment of a DC/DC converter device 1 for charging and/or discharging an energy store 8 from an AC network 4. The energy store 8 may also be replaced by a DC industrial network 3 or by an emergency energy store of an intermediate circuit for a pitch drive 2, wherein it is then not an AC network 4 which is connected on the input side, but an intermediate circuit of the control circuit for the pitch drive 2.

The fifth embodiment of FIG. 5a comprises all features of the fourth embodiment according to FIG. 4b, however with the input-side interference suppressor 550 and the output-side interference suppressor 650 being omitted.

The DC/DC converter device 1 of FIG. 5a furthermore has a first diode 801 and a second diode 802. The anode of the first diode 801 is here connected to the negative output potential tap 701, and the cathode of the first diode 801 is connected to the input intermediate circuit center point 503. The anode of the second diode 802 is connected to the input intermediate circuit center point 503, and the cathode of the second diode 802 is connected to the positive output potential tap 702.

According to FIG. 5a, a polarity reversal capacitor 606, connected in parallel to the semiconductor switching element 601, is connected to the center tap M1 of the first half bridge H1. Furthermore, a polarity reversal capacitor 607, connected in parallel to the semiconductor switching element 602, is connected to the center tap M1 of the first half bridge H1.

Similarly, a polarity reversal capacitor 608, connected in parallel to the semiconductor switching element 603, is connected to the center tap M2 of the second half bridge H2. Correspondingly, a polarity reversal capacitor 609, connected in parallel to the semiconductor switching element 604, is connected to the center tap M2 of the second half bridge H2.

The polarity reversal capacitors 606, 607, 608, 609 have the effect of limiting the voltage increase rate and hence reducing the switch-off losses and improving the EMC behavior in respect of interference emission. The polarity reversal capacitors may also be referred to as ZVS capacitors or snubber capacitors (ZVS: zero voltage switching).

FIG. 5b shows the fifth embodiment shown in FIG. 5a for a general DC/DC conversion as a further embodiment and enjoying the advantages shown in respect of the fifth embodiment, in particular in respect of efficiency, EMC and zero voltage switching behavior. On the input side, a DC source, for example a drive-related intermediate circuit, a DC energy source such as a solar generator, or a DC energy store may be connected. On the output side, a DC industrial network segment 2 of a DC industrial network 4 or an emergency energy store of a pitch drive 2 may for example be connected.

Advantageously, a DC voltage is provided on the input side at the positive and negative input conductors 401, 402, and a midpoint voltage symmetrical thereto is provided at the GND input. Diverging from the fifth embodiment in FIG. 5a, an output intermediate circuit with an output capacitor bridge 703, 704 is arranged on the output side. The output intermediate circuit center point 705 is—as in FIG. 4a—connected via a coupling line 750 to the input intermediate circuit center point 503, so that the statements made in this connection for the embodiment in FIG. 4a apply.

The GND terminal does not necessarily have to be used. The control unit 610 is here preferably configured to control the semiconductor switching elements 601, 602, 603, 604 such that the first half bridge H1 and the second half bridge H2 are controlled in-phase or preferably phase-shifted with a 180° phase shift. The ratio of the switch-on times of the input-side semiconductor switching elements 601, 603 to the switch-on times of the load-side semiconductor switching elements 602, 604 is in particular settable or constant, meaning it has a predetermined quotient. With a phase shift diverging slightly from the in-phase state or from 180°, the balance of the mean output voltage relative to GND can be achieved at the output potential taps 701 and 702. Also, the control unit 610 is preferably configured to switch off one of the semiconductor switches 601, 602, 603 and 604 slightly earlier in order to achieve the balance of the mean output voltage relative to GND at the output potential taps 701 and 702.

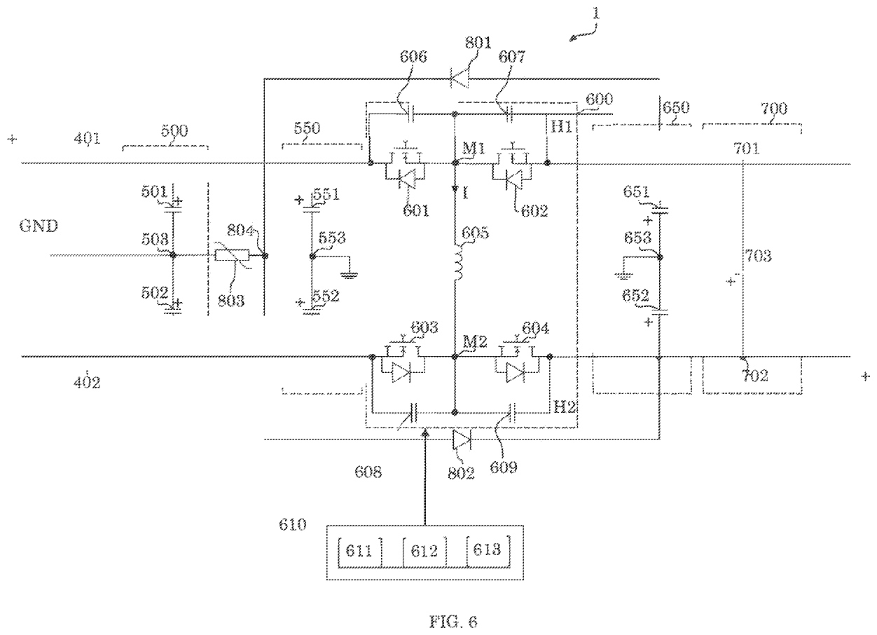

FIG. 6 shows a schematic diagram of a sixth embodiment of a DC/DC converter device 1 for output-side provision of a variably settable DC output potential. The sixth embodiment der FIG. 6 comprises all features of the fifth embodiment according to FIG. 5a.

Furthermore, the DC/DC converter device 1 according to FIG. 6 has an overvoltage protection element 803 which is coupled between the input intermediate circuit center point 503 and a node 804 to which the cathode of the first diode 801 is connected and to which the anode of the second diode 802 is connected.

The overvoltage protection element 803 is for example a varistor or a bidirectional suppressor diode, for example a bidirectional transil diode.

The function of the diodes 801, 802 and of the overvoltage protection element 803 is to protect the semiconductor switching elements 601, 602, 603, 604 from overvoltage. This overvoltage can arise if the mean potential of the output potential taps 701 and 702 were to shift greatly relative to the input intermediate circuit center point 503. This is achieved by the diodes 801, 802 and the overvoltage protection element 803 in particular in that the potential of the output potential tap 702 cannot become more negative than the potential of the input intermediate circuit center point 503, and the potential at the output potential tap 701 cannot become more positive than the potential of the input intermediate circuit center point 503.

Alternatively and not shown, a series connection made from a first overvoltage protection element and from the first diode 801 can be arranged between the input intermediate circuit center point 503 and the negative output potential tap 701, and a series connection made from a second overvoltage protection element and the second diode 802 can be arranged between the input intermediate circuit center point 503 and the positive output potential tap 702.

For the embodiment shown in FIG. 6, the control unit 610 is here preferably configured to control the semiconductor switching elements 601, 602, 603, 604 such that the input-side semiconductor switching element 601 of the first half bridge H1 and the load-side semiconductor switching element 604 of the second half bridge H2 have slightly overlapping switch-on times, and/or that the input-side semiconductor switching element 603 of the second half bridge H2 and the load-side semiconductor switching element 602 of the first half bridge H1 have slightly overlapping switch-on times. The ratio of the switch-on times of the input-side semiconductor switching elements 601, 603 to the switch-on times of the load-side semiconductor switching elements 602, 604 is in particular settable or constant, meaning it has a predetermined quotient.

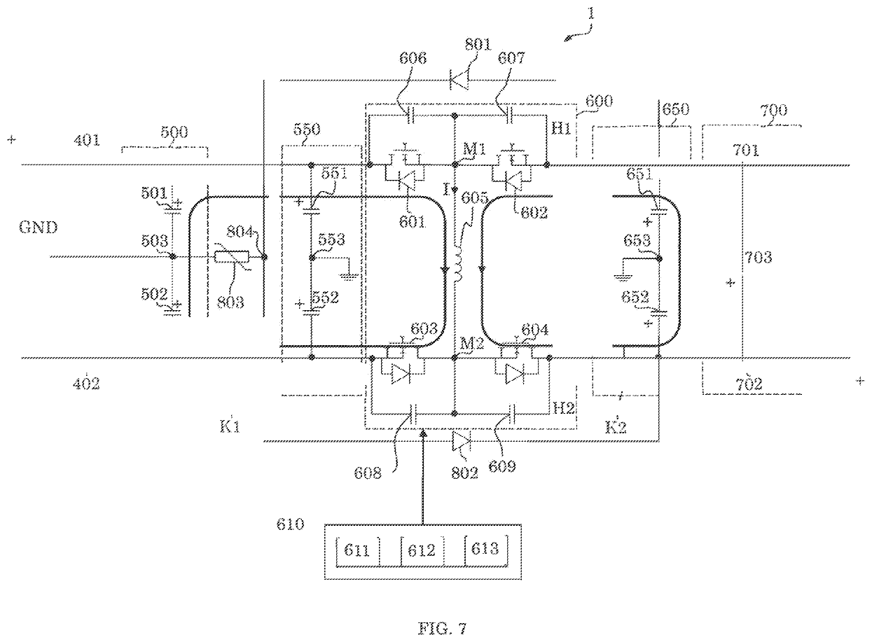

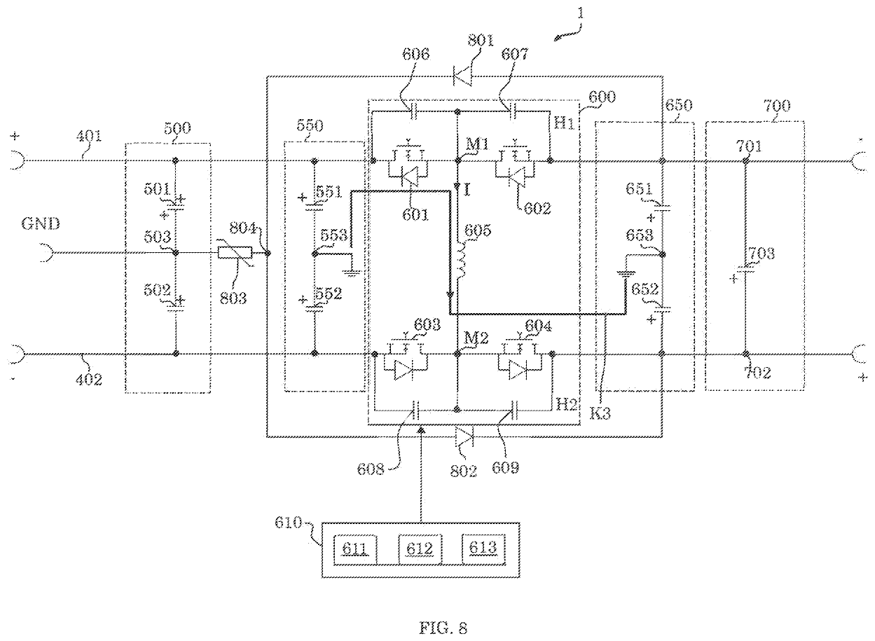

In addition, the control unit 610 is preferably configured to switch off one of the input-side semiconductor switching elements 601, 603 of the two half bridges H1, H2 earlier than the other input-side semiconductor switching element 603, 601 of the two half bridges H1, H2, such that a coupling of an input-side primary circuit K1 (see FIG. 7) and of a load-side secondary circuit K2 (see FIG. 7) is provided via the choke 605. A coupling of this type for the circuit K3 of a balancing current is shown in FIG. 8. Details of this are explained below.

As FIG. 6 shows, the semiconductor switching elements 601, 602, 603, 604 can be designed as MOSFETs. The control unit 610 can here be preferably configured to control the gates of the MOSFETs 601, 602, 603, 604 of the half bridges H1, H2 with control signals G1, G2, G3, G4 phase-shifted in such a way that a coupling of the input-side primary circuit K1 (see FIG. 7) and of the load-side secondary circuit K2 (see FIG. 7) is provided via the choke 605.

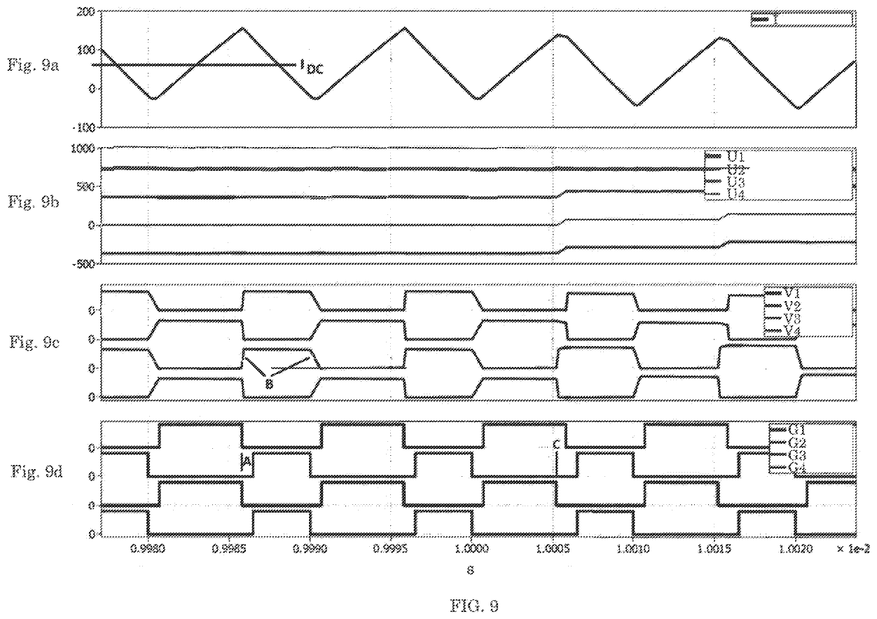

The above, in particular the mode of operation of the choke 605 operable as a flying inductance and the output potential control, is explained in more detail in the following on the basis of the diagrams in FIG. 9. In this connection, FIG. 9a shows the current in the choke 605 and FIG. 9b shows the output voltage referred to as U1, plus against ground referred to as U2, minus against ground referred to as U3, and the mean output voltage referred to as U4. Furthermore, FIG. 9c shows the reverse voltages of the MOSFETs 601, 602, 603 and 604, wherein V1 is the reverse voltage at MOSFET 601, V2 the reverse voltage at MOSFET 602, V3 the reverse voltage at MOSFET 603, and V4 the reverse voltage at MOSFET 604. Furthermore, FIG. 9d shows the gate signals of the MOSFETs 601, 602, 603 and 604. Here the gate signal G1 is associated with MOSFET 601, the gate signal G2 with MOSFET 602, the gate signal G3 with MOSFET 603 and the gate signal 604 with MOSFET 604.

As FIG. 9a shows, the mean value of the current flowing through the choke 605 is 60 A. This is the sum of the mean input current of the primary circuit K1 (see FIG. 7) and the mean output current of the secondary circuit K2 (see FIG. 7). With reference to FIG. 9d, times A for changeover of the polarity reversal capacitors 606, 607, 608 and 609 are provided in the gate signals G1, G2, G3, G4 of the MOSFETs 601, 602, 603, 604. The changeover can be seen at the flank B of the MOSFET reverse voltages according to FIG. 9c. The maximum current of +150 A according to FIG. 9a in the choke 605 effects a rapid changeover, whereas the minimum current of −30 A according to FIG. 9a in the choke 605 effects a slow changeover and hence a flat flank B of the MOSFET reverse voltages in FIG. 9c. Switch-on of the MOSFETs, see A in FIG. 9d, then takes place whenever the reverse voltage of the MOSFET is zero, in order to reduce or avoid switch-on losses. When the MOSFETs switch off (see A in FIG. 9d), the MOSFET reverse voltage increases, during the changeover across them, so slowly that the reverse voltage during switch-off remains low, i.e. the result is a dU/dt-limited switch-off. In comparison with hard switch-off, the result of this is very much lower switch-off losses.

Zero voltage switching of the MOSFETs 601, 602, 603 and 604 is characterized by loss-free switch-on with a reverse voltage of zero and by a loss-reduced switch-off with a voltage increase rate limited by the polarity reversal capacitors 606, 607, 608 and 609. Zero voltage switching requires that the choke current according to FIG. 9a between two switching operations of the MOSFETs 601, 602, 603 and 604 has at least one zero crossing.

At the time C in FIG. 9d, the MOSFET 603 is switched off earlier than the MOSFET 601. This results in the coupling mentioned in the above (see circuit K3 in FIG. 8) of the circuits. The balance of the output voltage against ground shifts here with every switching operation (cf. FIG. 9b at time C). Balance control can thus take place.

As already set forth above, there are two possibilities for balance control: firstly a slightly earlier switching off of single or several MOSFETs and secondly a slight phase shift of the gate signals G1, G2, G3, G4 of the two half bridges H1, H2 relative to one another.

As FIGS. 6, 7, 8 and 10 show, the control unit 610 can have two current controllers which are in particular independent of one another. The control unit 610 thus comprises in particular a load current controller 611 and a balancing current controller 612. Also, the control unit 610 comprises a differential voltage controller 613.

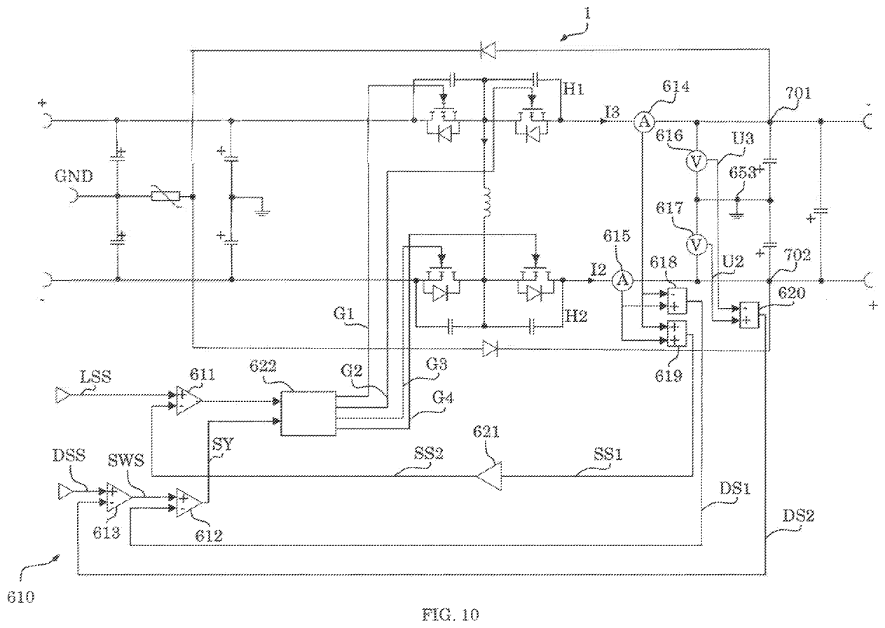

The load current controller 611 is in particular configured to set the ratio of the switch-on times of the input-side MOSFETs 601, 603 to the switch-on times of the load-side MOSFETs 602, 604. The balancing current controller 612 provides a balancing current (see circuit K3 in FIG. 8 and SY in FIG. 10) for balancing of the potential at the negative output potential tap 701 and of the potential at the positive output potential tap 702 relative to ground potential.

The differential voltage controller 613 is in particular configured to provide a set value SWS (see FIG. 10) for a setting signal SY depending on at least one measured voltage U2, U3 (see FIG. 10) in the load-side secondary circuit K2. The differential voltage controller 613 is here slower than the balancing current controller 612.

As set forth above, the high-speed load current controller 611 influences the ratio of the switch-on times (duty cycles) of the input-side MOSFETs 601, 603 to the switch-on times of the load-side MOSFETs 602, 604. With a ratio lower than 1, the input voltage is stepped down, with a ratio higher than 1 it is stepped up, and with a ratio of 1 the input voltage is only inverted.

The differential current controller affects the switch-off time of individual MOSFETs 601, 602, 603, 604 or the phase shift. As set forth above, the balancing current controller 612 can provide a balancing current according to FIGS. 8 and 10. The differential voltage controller 613 supplies the set value SWS for the setting signal SY. For example, it can ensure that a ground fault current against ground caused by unequal fouling of the output potential taps 701 and 702 is compensated by the balancing current controller 612, and hence the output voltage remains ground-symmetrical. It is also preferably suitable to compensate for the tendency towards imbalance caused by timing tolerances in the gate signals G1, G2, G3, G4. Details of this are explained with reference to FIG. 10.

FIG. 10 shows here the schematic diagram of FIG. 6 with balance control included, wherein some of the reference numerals shown in FIG. 6 have been omitted from FIG. 10 for reasons of clarity.

The control unit 610 shown in FIG. 10 may also be referred to as a regulating unit or regulating device and is configured for balance control. The control unit 610 in FIG. 10 comprises a load current controller 611, a balancing current controller 612 and a differential voltage controller 613. Furthermore, the DC/DC converter device 1 according to FIG. 10 comprises a first current measuring device 614, a second current measuring device 615, a first voltage measuring device 616, a second voltage measuring device 617, a first subtracting unit 618, a summing unit 619, a second subtracting unit 620, a halving unit 621 and a PWM generator 622 (PWM: pulse width modulation).

The first current measuring device 614 is configured to measure the current I3 flowing from the first half bridge H1 to the negative output potential tap 701. Correspondingly, the second current measuring device 615 is configured to measure the current I2 flowing from the second half bridge H2 to the positive output potential tap 702.

The first subtracting unit 618 is suitable for providing a first differential signal DS1 from a difference between the current I2 and the current I3 on the output side. The summing unit 619 by contrast totals the currents I2 and I3 and provides on the output side a sum signal SS1 depending thereon.

The halving unit 621 halves the first sum signal SS1 provided by the summing unit 619, and provides on the output side a second sum signal SS2 (SS2=0.5*SS1).

The first voltage measuring device 616 is configured to measure a voltage present between the negative output potential tap 701 and ground, and depending on this measurement to provide on the output side a first voltage value U3 (minus against ground).

Furthermore, the second voltage measuring device 617 is configured to measure a voltage present between the positive output potential tap 702 and ground, and depending on this measurement to provide on the output side a second voltage signal U2 (plus against ground). The second subtracting unit 620 forms from the difference between U2 and U3 a second differential signal DS2 and provides the latter on the output side.

The differential voltage controller 613 receives on the input side the second differential signal DS2 from the second subtracting unit 620 and a differential voltage set value DSS, and provides on the output side the balancing current set value SWS depending thereon and passes said value to the balancing current controller 612. The balancing current controller 612 receives on the input side the balancing current set value SWS and the first differential signal DS1 from the first subtracting unit 618. Depending on these received signals DS1, SWS, the balancing current controller 612 provides on the output side the setting signal SY and passes said signal to the PWM generator 622.

The load current controller 611 receives on the input side the halved sum signal SS2 and a load current set value LSS, and provides on the output side a setting signal depending thereon for setting the switch-on times of the MOSFETs 601, 602, 603, 604.

The PWM generator generates the gate signals G1, G2, G3, G4 for the MOSFETs 601, 602, 603, 604 depending on the received setting signal ES and on the received setting signal SY.

The differential voltage controller 613 is in particular so slow that in the event of an abruptly occurring fault current it initially cannot change the current at first. The changeover of the capacitors 651 and 652 is preferably not disrupted here. As a result, the system acts like a system galvanically isolated from the network 4. Before the differential voltage controller 613 or balancing current controller 612 can act in such an event, the DC/DC converter 600 is preferably switched off. If required, the system could remain in operation even with a ground fault, without driving a current into a ground fault.

In the embodiments shown in FIGS. 3, 4b, 5a, 6, 7 8 and 10, it is possible by dispensing with cable 750, i.e. by quasi-isolation, and dispensing with a galvanic connection between the input side and the output side, to continue operation of the DC converter device 1 without restriction outside the semiconductor bridges H1, H2 in the event of a ground fault. This factor is a substantial aspect in particular with regard to personnel safety and operating safety.

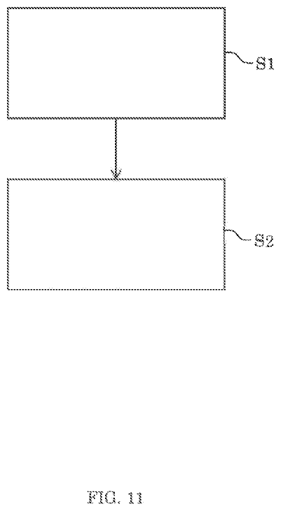

FIG. 11 furthermore shows a schematic flow diagram of a method for operating a DC/DC converter device 1 for operation of a wind turbine or of an industrial DC supply network 3. The DC/DC converter device 1 is for example designed as explained in the preceding figures.

In step S1, the DC/DC converter device 1 is coupled to a DC energy source such as an AC/DC converter 400 of a multiphase network 4, to a drive-related intermediate circuit, to a solar generator, to a DC energy store or similar and to a DC energy sink, for example a DC energy store 8, for example an electric vehicle, a network segment 2 of a DC industrial network 3, an emergency energy store etc. It is also conceivable to use the DC/DC converter device between an emergency energy store and the intermediate circuit of one or more pitch or yaw drives 2 of a wind turbine 3; between intermediate circuits of electric drives for intermediate circuit coupling or backup by means of an energy store or energy source; between various network segments 2 of a DC industrial network 3 or similar, in which electrical energy can be transferred preferably bidirectionally at identical or different, preferably variable, voltage levels.

In step S2, the choke 605 of the DC/DC converter 600 connecting the center tap M1 of the first half bridge H1 and the center tap M2 of the second half bridge H2 is operated as a flying inductance.

Although the present invention was described on the basis of embodiments, it is modifiable in many ways.

### REFERENCE NUMERAL LIST

1 DC/DC converter device
2 Pitch drive or DC industrial network segment
3 Wind turbine or DC industrial network
4 AC network
5 Charging cable
6 Network connection point
7 Multiphase energy supply network
8 DC energy store
101 Connecting terminal
102 Connecting terminal
103 Connecting terminal
200 EMC filter device
300 LCL filter device
400 AC/DC converter
401 Positive input conductor
402 Negative input conductor
500 Input intermediate circuit
501 Intermediate circuit capacitor
502 Intermediate circuit capacitor
503 Input intermediate circuit center point
550 Interference suppressor
551 Interference suppression capacitor
552 Interference suppression capacitor
553 Node
600 DC/DC converter
601 Semiconductor switching element
602 Semiconductor switching element
603 Semiconductor switching element
604 Semiconductor switching element
605 Choke
606 Polarity reversal capacitor
607 Polarity reversal capacitor
608 Polarity reversal capacitor
609 Polarity reversal capacitor
610 Control unit
611 Load current controller
612 Balancing current controller
613 Differential voltage controller
614 First current measuring device
615 Second current measuring device
616 First voltage measuring device
617 Second voltage measuring device
618 First subtracting unit
619 Summing unit
620 Second subtracting unit
621 Halving unit
622 PWM generator
650 Interference suppressor
651 Interference suppression capacitor
652 Interference suppression capacitor
653 Node
700 Output intermediate circuit
701 Output potential tap
702 Output potential tap
703 Output capacitor
704 Output capacitor
705 Output intermediate circuit center point
750 Coupling line
801 Diode
802 Diode
803 Overvoltage protection element
804 Node
A, B, C Times
E Setting signal
G1 Gate signal for semiconductor switching element 601
G2 Gate signal for semiconductor switching element 602
G3 Gate signal for semiconductor switching element 603
G4 Gate signal for semiconductor switching element 604
H1 First half bridge
H2 Second half bridge
I Current
I2 Current
I3 Current
K1 Circuit
K2 Circuit
K3 Circuit
L1 Phase
L2 Phase
L3 Phase
M1 Center tap of first half bridge
M2 Center tap of second half bridge
s Time in seconds
S1, S2 Method steps
SY Setting signal
U1 Output voltage
U2 Plus against ground
U3 Minus against ground
U4 Mean output voltage
V1 Voltage at semiconductor switching element 601
V2 Voltage at semiconductor switching element 602
V3 Voltage at semiconductor switching element 603
V4 Voltage at semiconductor switching element 604
GND Midpoint potential at input intermediate circuit center point

1. A DC/DC converter device for operating a wind turbine, an electric drive system or an industrial DC supply network with electrical energy, having:
an input intermediate circuit which has a number of intermediate circuit capacitors connected between a positive input conductor and a negative input conductor; and
a DC/DC converter connected downstream of the input intermediate circuit, which has a first half bridge connected to the positive input conductor and a second half bridge connected to the negative input conductor, wherein the center tap of the first half bridge and the center tap of the second half bridge are connected via a choke.

2. The DC/DC converter device according to claim 1, further comprising:
an AC/DC converter couplable to a number of AC phases, in particular a 3-point AC/DC converter, connected upstream of the input intermediate circuit at the input conductors; or
a DC energy source, in particular a solar generator, or a DC energy store, in particular a battery, is connected to the input intermediate circuit at the input conductors.

3. The DC/DC converter device according to claim 1, wherein at least one pitch drive, or a yaw drive of a wind turbine, an intermediate circuit of an electric drive, or at least one DC network segment of a DC industrial network, is connected downstream of an output intermediate circuit of the DC/DC converter.

4. The DC/DC converter device according to claim 1, wherein a choke of the DC/DC converter is operable as a flying inductance.

5. The DC/DC converter device according to claim 1, wherein the DC/DC converter device is a transformerless DC/DC converter device.

6. The DC/DC converter device according to claim 1, wherein the DC/DC converter is bidirectional DC/DC converter for stepping voltages up and/or down.

7. The DC/DC converter device according to claim 1, wherein each respective half bridge has a series connection of two semiconductor switching elements.

8. The DC/DC converter device according to claim 7, wherein the semiconductor switching elements are each is designed as a MOSFET, preferably as a SiC MOSFET, or as an IGBT or as a SiC cascode.

9. The DC/DC converter device according to claim 7, wherein the DC/DC converter device has a control unit which is configured to control the semiconductor switching elements such that two corresponding semiconductor switching elements of the two half bridges respectively switch simultaneously, in particular with an identical switch-on time-lag.

10. The DC/DC converter device according to claim 7, wherein the DC/DC converter device has a control unit which is configured to control the half bridges with a phase shift, in particular with a 180° phase shift.

11. The DC/DC converter device according to claim 1, further comprising an interference suppressor arranged between the input intermediate circuit and the DC/DC converter which has two interference suppression capacitors connected in parallel to the intermediate circuit capacitors, wherein a node connecting the two interference suppression capacitors is connected to ground potential.

12. The DC/DC converter device according to claim 1, further comprising an output intermediate circuit connected downstream of the DC/DC converter and having a number of output capacitors which are connected between a negative output potential tap and a positive output potential tap of the DC/DC converter device.

13. The DC/DC converter device according to claim 12, wherein the intermediate circuit capacitors of the input intermediate circuit form an input capacitor bridge with an input intermediate circuit center point, and the output capacitors of the output intermediate circuit form an output capacitor bridge with an output intermediate circuit center point, wherein the input intermediate circuit center point is connected via a coupling line to the output intermediate circuit center point.

14. The DC/DC converter device according to claim 12, further comprising a load-side interference suppressor arranged between the DC/DC converter and the output intermediate circuit which has two interference suppression capacitors connected in parallel to the number of output capacitors of the output intermediate circuit, wherein a node connecting the two interference suppression capacitors is connected to ground potential.

15. The DC/DC converter device according to claim 9, wherein the control unit is configured to control the semiconductor switching elements such that the input-side semiconductor switching element of the first half bridge and the load-side semiconductor switching element of the second half bridge have overlapping switch-on times, and/or that the input-side semiconductor switching element of the second half bridge and the load-side semiconductor switching element of the first half bridge have overlapping switch-on times, wherein a ratio of the switch-on times of the input-side semiconductor switching elements to the switch-on times of the load-side semiconductor switching elements preferably has a predetermined quotient.

16. The DC/DC converter device according to claim 9, wherein the control unit is configured to switch off one of the input-side semiconductor switching elements of the two half bridges earlier than the other input-side semiconductor switching element of the two half bridges, such that coupling of an input-side primary circuit and of a load-side secondary circuit is provided via a choke.

17. The DC/DC converter device according to claim 9, wherein the semiconductor switching elements are MOSFETs and the control unit is configured to control the gates of the MOSFETs of the half bridges with control signals phase-shifted in such a way that coupling of an input-side primary circuit and of a load-side secondary circuit is provided via a choke.

18. The DC/DC converter device according to claim 9, wherein the control unit has a load current controller, a balancing current controller and a differential voltage controller, wherein the load current controller is configured to set the ratio of the switch-on times of the input-side semiconductor switching elements to the switch-on times of the load-side semiconductor switching elements,
wherein the balancing current controller is configured to provide a setting signal for balancing the potential at the negative output potential tap and the potential at the positive output potential tap relative to the ground potential, and
wherein the differential voltage controller is configured to provide a set value for the setting signal depending on at least one measured voltage in the load-side secondary circuit.

19. The DC/DC converter device according to claim 18, wherein the differential voltage controller is slower than the balancing current controller.

20. The DC/DC converter device according to claim 12, wherein an anode of a first diode is coupled to the negative output potential tap and a cathode of the first diode is coupled to the input intermediate circuit center point, and an anode of a second diode is coupled to the input intermediate circuit center point and a cathode of the second diode is coupled to the positive output potential tap.

21. The DC/DC converter device according to claim 20, wherein the anode of the first diode is connected to the negative output potential tap and the cathode of the first diode is connected to the input intermediate circuit center point, and the anode of the second diode is connected to the input intermediate circuit center point and the cathode of the second diode is connected to the positive output potential tap.

22. The DC/DC converter device according to claim 20, wherein an overvoltage protection element is coupled between the input intermediate circuit center point and a node to which the cathode of the first diode is connected and to which the anode of the second diode is connected.

23. The DC/DC converter device according to claim 20, wherein a series connection made from a first overvoltage protection element and from the first diode is arranged between the input intermediate circuit center point and the negative output potential tap, and a series connection made from a second overvoltage protection element and the second diode is arranged between the input intermediate circuit center point and the positive output potential tap.

24. The DC/DC converter device according to claim 1, further comprising an EMC filter device and an LCL filter device connected downstream of the EMC filter device and are coupled between three input-side connecting terminals for three phases of a multiphase network, and the AC/DC converter.

25. The DC/DC converter device according to claim 1, wherein the AC/DC converter arranged on the input side is a 3-point AC/DC converter.

26. The DC/DC converter device according to claim 7, further comprising a polarity reversal capacitor is connected in parallel to each semiconductor switching element to achieve ZVS switchover behavior.

27. A method for operating a DC/DC converter device for operation of a wind turbine, of an electric drive or of an industrial DC supply network with electrical energy, preferably according to claim 1, wherein the DC/DC converter device comprises an intermediate circuit which has a number of intermediate circuit capacitors connected between a positive input conductor and a negative input conductor, and a DC/DC converter connected downstream of the input intermediate circuit which has a first half bridge connected to the positive input conductor and a second half bridge connected to the negative input conductor, comprising:
operation of a choke, connecting a center tap of the first half bridge and a center tap of the second half bridge, of the DC/DC converter as a flying inductance.
